(19) United States
(12) Patent Application Publication
(10) Pub. No.: US 2010/0254698 A1
(43) Pub. Date: Oct. 7, 2010

(54) Antistatic Camera Lens Device

(76) Inventor: Michael Louis, Boca Raton, FL (US)

Correspondence Address: ROBERT M. SCHWARTZ, P.A., P.O. BOX 221470, HOLLYWOOD, FL, 33022, US

(21) Appl. No.: 12/749,597

(22) Filed: Mar. 30, 2010

Related U.S. Application Data
(60) Provisional application No. 61/164,527, filed on Mar. 30, 2009.

(51) Int. Cl. G03B 17/00

(52) U.S. Cl. 396/448

(57) ABSTRACT

An article is detachably connected to a camera lens, the article containing an electrostatic material that moves dust and lint from the lens.

This application claims the benefit of U.S. Provisional Patent Application Ser. No. 61/164,527 filed Mar. 30, 2009, the disclosure of which is incorporated by reference in its entirety.

### SUMMARY OF THE INVENTION

The present invention is an article that has incorporated thereon, an electrostatic material suitable for moving dust and lint from a camera lens surface.

### BRIEF DESCRIPTION OF THE DRAWINGS

FIG. 1 is a perspective view of a camera with the article.

FIG. 2 is a front partial view of the article positioned on a lens.

FIG. 3 is a cut away along line A-A of FIG. 2 showing the device and lens periphery.

FIG. 4 is a cut away along line A-A of FIG. 2 showing the device and lens periphery.

FIG. 5 is a side cross section of a camera lens with a lens hood.

FIG. 6 is a side cross section of a lens hood.

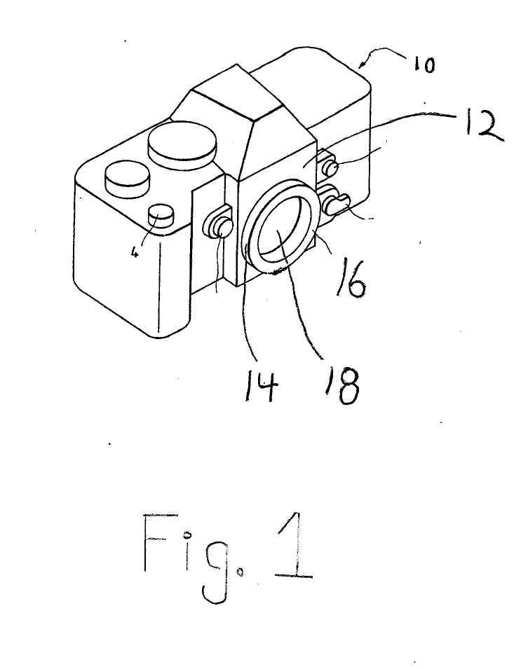

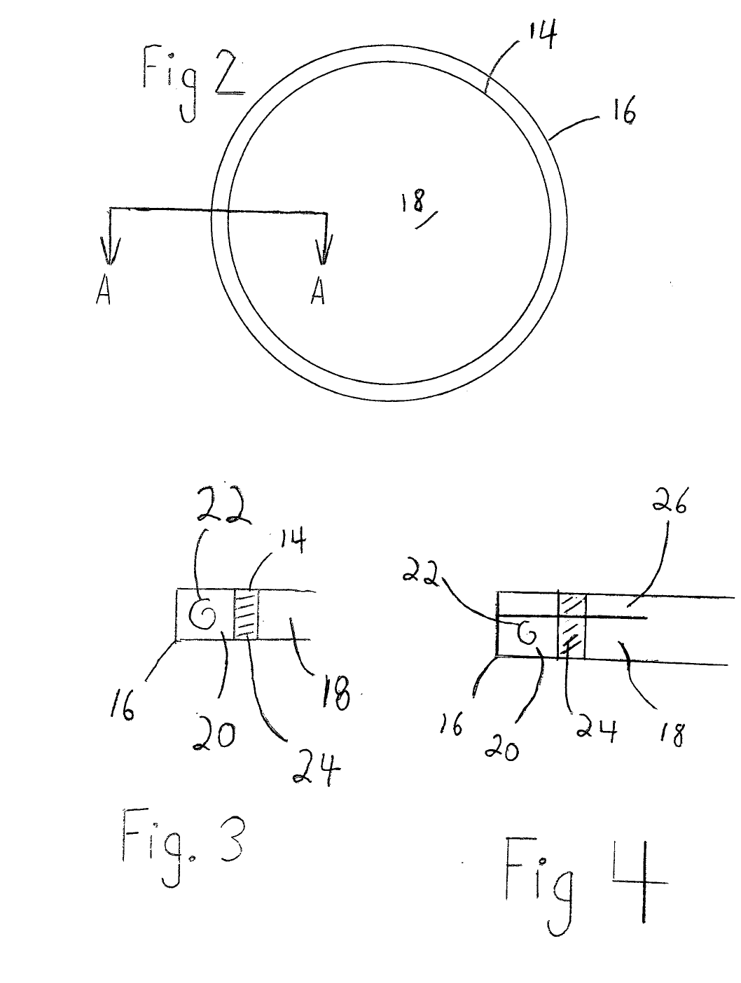

### DETAILED DESCRIPTION OF THE PREFERRED EMBODIMENTS

A camera 10 has a front face 12. A lens 18 is surrounded by a circumferential lens housing 14. In one embodiment, the article is a lens cover 16 constructed and arranged to be secured over lens 18 by detachably connecting to lens housing 14. Lens cover 16 has formed therein a cavity 20 that contains an electrostatic material 22. Lens cover 16 connects to housing 14 by screw threads 24.

The electrostatic material 22 is any material that provides an electrostatic charge sufficient to deter accumulation of lint and dust on the surface. The invention utilizes any appropriate material or device form moving dust and lint from either or both of front and rear camera lenses. Electrostatic repelling fibers are known in the art and are used, in one example, as electrostatic dissipative (ESD) fiber yarns, in electrostatic gloves. In one embodiment, electrostatic material 22 is a silver-plated, monofilament, continuous thread woven together with elastic nylon to assure full conductivity.

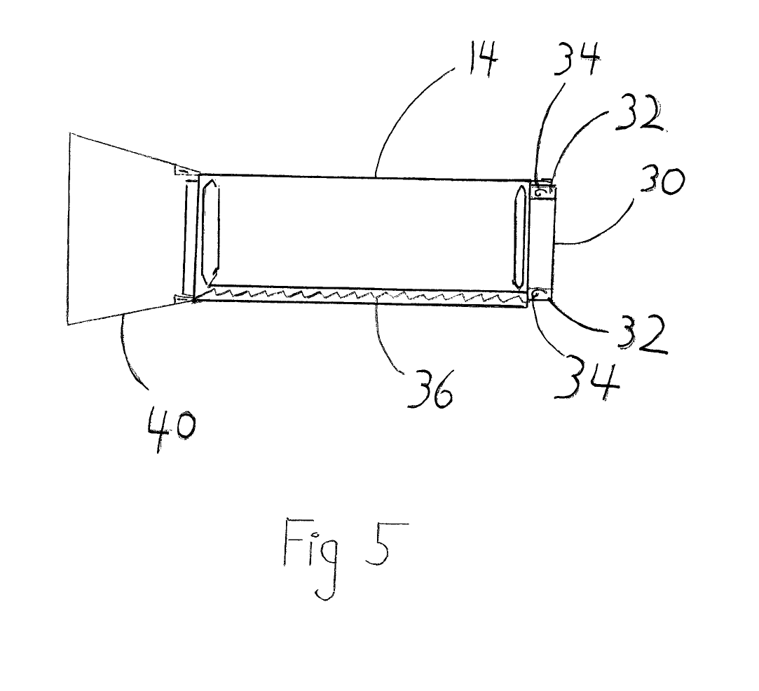

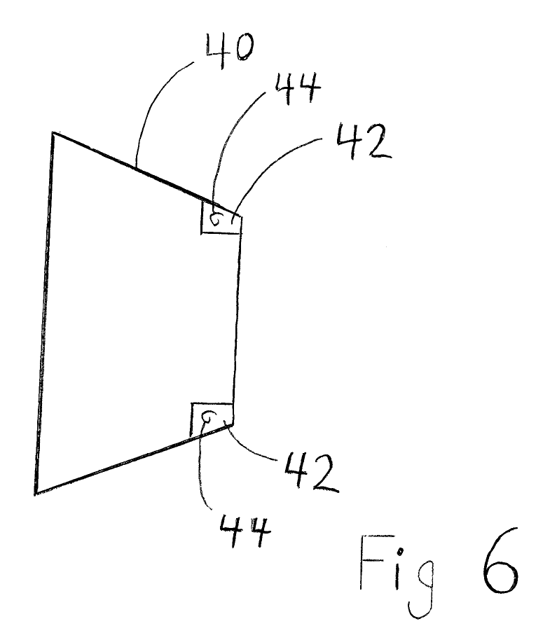

Lens 14 is sometimes used with a hood 40 as is known in the art. In one embodiment, as shown in FIG. 5, lens 14 has incorporated therein an electrical conducting wire 36, or other acceptable electrical propagation mechanism, that can propagate electricity from electrical supply of the camera to any one or more conductive regions on or affixed to lens housing 14.

A lens cap 30 may be placed on either or both ends of lens housing 14. Lens cap 30 is constructed and arranged with a circumferential cavity 32 that has electrostatic material 34 disposed therein.

As seen in FIG. 6, lens hood 50 is constructed and arranged with a circumferal cavity 42 that has electrostatic material 44 disposed therein.

In use, a camera 10 has at least one lens 18 circumferentially surrounded by a lens housing 14. A lens cover 16 is secured to lens housing 14. Lens cover 16 is formed of any appropriate material including, but not limited to, plastic, composites, metal, and the like. The lens cover 16 is secured by any acceptable mechanism as is known in the art. In a preferred embodiment, lens housing 14 and lens cover 16 have complementary screw threads 24 that secure lens cover 16 to lens housing 14 by screw fit attachment. In one embodiment, lens cover 16 has a non-focal lens 26 that covers lens 18 when lens cover 16 is secured onto lens housing 14. Non-focal lens 26 is formed of any appropriate lens material so as to be transparent. Alternatively, non-focal lens 26 is a lens filter, such as polarized light filter as is known in the art.

In one embodiment, electrostatic material 22 has an electrical charge that repels dust and lint particles away from the inner circumferential area of lens cover 16. The repel effect assists in keeping dust and lint from accumulating on surfaces including, but not limited to, lens 18 and non-focal lens 26.

The electrostatic material 22 can be varied dependent on the strength of electromagnetic repulsion field desired. Additionally, electrical power, resistors, and appropriate electrical component materials are used as needed in conjunction with electrostatic material 22. Although reference is made to electrostatic material 22, the present invention may incorporate electrical power and components to any electrostatic material regardless of placement or housing.

In one embodiment, electrostatic material 22 has a charge that attracts dust and lint particles such that dust and lint particles are pulled circumferentially outward off a lens and accumulate about the circumference of a lens.

Electrostatic material is not intended to be limited to placement in cavities. Electrostatic material according to the present invention is disposed on a member in any manner that allows an electrostatic charge to disrupt the accumulation of dust and lint on either or both the front or rear portion of a camera lens.

In an embodiment, a rechargeable cell and solar panel can be incorporated on or in a camera hood. The cell is wired to an electrical mechanism to move dust and other particles from a camera lens.

In one embodiment, a camera lens storage housing is provided with electrostatic material incorporated therein such that a camera lens is stored in an environment fee of dust and other particles.

The present invention is also suitable for use on lens extension tubes which have end and front caps that also typically build up dust. The extension tube which has glass lenses also is susceptible to dust build up.

A mechanism such as a rechargeable cell could be built into the lens caps which might plug into a charger while not in use to build up its static capabilities.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An article for inhibiting dust and lint accumulation comprising:
a. a member constructed and arranged to be detachably connected to a camera lens housing;
b. an electrostatic material disposed in said member;
wherein said electrostatic material emits an electrostatic charge sufficient to move dust and lint particles off a camera lens.

2. The article of claim 1 wherein said member connects to said lens housing by complementary screw threads.

3. The lens cover of claim 1 wherein said member connects to said lens housing by a snap fit arrangement.

4. The lens cover of claim 1 wherein said member connects to said lens housing by a quick connect-disconnect arrangement.

5. The member of claim 1 wherein said member has a non-focal lens covering a focal camera lens.

6. The member of claim 1 wherein said electrostatic material is disposed about the circumference of said member.

7. The member of claim 1 wherein said electrostatic material is removably disposed about the circumference of said member.

8. The article of claim 1 wherein said member is a lens cap, a lens cover, a lens hood, or combinations thereof.

9. The article of claim 1 wherein said electrostatic material repels dust and lint.

10. The article of claim 1 wherein said electrostatic material requires no source of electricity.

11. The article of claim 1 wherein said electrostatic material utilizes a source of electricity.

12. The article of claim 1 wherein said electrostatic material attracts dust and lint.
